(19) United States
(12) Patent Application Publication
(10) Pub. No.: US 2001/0045056 A1
(43) Pub. Date: Nov. 29, 2001

(54) Edging

(76) Inventor: John K. Hulett, Plymouth, MN (US)

Correspondence Address: DORSEY & WHITNEY LLP, PILLSBURY CENTER SOUTH, 220 SOUTH SIXTH STREET, MINNEAPOLIS, MN, 55402-1498, US

(21) Appl. No.: 09/784,796

(22) Filed: Feb. 15, 2001

Related U.S. Application Data
(60) Provisional application No. 60/182,848, filed on Feb. 16, 2000.

(51) Int. Cl. A01G 1/00

(52) U.S. Cl. 47/33

(57) ABSTRACT

The present invention provides individual pieces of edging material wherein each piece has a wall with a bottom edge and generally parallel side edges, a base extending along at least a portion of the bottom edge, at least one ground engaging member extending from the base and an attachment structure at each side edge for joining pieces to form a fence-like edging assembly.

This application claims the priority benefit of a U.S. Provisional Application, Ser. No. 60/182,848, filed Feb. 16, 2000.

### BACKGROUND

The present invention relates to structures and materials for forming and/or defining boundaries and/or areas, and more particularly, to an edging apparatus including edging unity with engaging members for engaging adjacent edging units and ground engaging members for engaging the ground.

Edging used to separate sections of a lawn, yard, or garden is known. One edging, described in U.S. Pat. No. 4,644,685 (Tisbo), requires the user to dig a trench in the ground, insert the edging, and then fill in the trench around it. In this manner the edging can be constructed in a desired patten. The described edging serves the purpose for which it was made, but is limited by the considerable time required to dig the trench, erect the edging, and also to fill in the trench.

Another difficulty with constructing fences made from modular edging units includes the need to create edging barriers that must conform with non-90° angle curves. Specialized comer pieces may be made, but their use is limited to the types of comers for which they were especially constructed. Specifically constructed comer pieces may not be able to deal with the variety of angles and comers that may occur when placing a border edging around a lawn or garden or other yard area; for slight angles, the edging may be bent while it is placed in the ground. These solutions, however, are wasteful and inefficient. A need exists for a modular edging unit that may be conveniently and effectively attached at a variety of angles to one another and still maintain an attractive appearance.

A further problem with the prior art edging is the creation of a substantially smooth barrier surface that is pleasing to the eye. When some prior art edging is placed together at an angle, the edging may have gaps between adjacent pieces, e.g., between the base of one edging unit and the base of the second edging unit. These gaps are unattractive and may show the ground underneath or behind the edging. Gaps in the edging units detracts from the ability of the edging to replicate the appearance of a real fence structure. A need exists for a modular edging unit that, when placed together at a variety of angles to surround a desired area, presents a uniform and smooth surface that is pleasing to the eye.

A need exists, therefore, for an edging that is easy to position or erect and that also has enough rigidity to create an attractive and sturdy border edging structure. Preferably, this edging should be constructed so that the sections are easily attached to one another. Furthermore, the attachment members should be attachable at a range of desired angles. The edge presented for viewing should present a substantially uniform and smooth transition between each successive edging unit.

### SUMMARY

The present invention provides individual pieces of edging material and encompasses a number of the individual pieces joined to form a fence-like edging assembly. It encompasses a method of making the individual edging pieces and a method of and/or analyzing a number of them to form an edging assembly.

An advantage of the present invention is that it provides a large degree of flexibility in the design and shape of edging assemblies. For example, the individual edging pieces of the present invention may be used to form generally curved edging assemblies, straight wall or fence-like assembles and/or assemblies having a geometric shape, i.e., assemblies having generally straight portions of a related length which extend at a selected angle, e.g., rectangular, etc.

The present invention comprises removably attachable modular sections that are placed on the ground in a generally upright position. In some embodiments, the sections have a decorative side viewing surface; in other embodiments, both sides may be the same or similar. Each edging section may have an interlocking member on each end for connection to other interlocking edging sections. The edging sections further comprise ground engaging members for engaging the ground. The edging sections are removably attached to one another by means of the connection members and then placed on the ground in a generally vertical manner through the use of the ground engaging members. Each of the modular sections may have one end rounded in such a way so that no matter the angle in which successive modular sections are placed together, the bottom edge presents a substantially uniform and attractive appearance.

In one embodiment of the edging of the present invention, the edging sections each comprise a base extending from a first end to a second end of the section, a substantially vertical barrier disposed on a first side of the base and running substantially from the first end to the second end of the section, at least one ground edging member fixedly attached and downwardly extending from a second side of the base, a first attachment member fixedly attached to the first end, and a second attachment member fixedly attached to the second end whereby the second attachment member is shaped to operably couple or interlock with the first attachment member of an adjoining modular edging section at a desired angle.

Another embodiment of the present invention may include a wall and a base connected to a lower portion of the wall, wherein the base has an outer edge, one end of the edge including a curved portion, and at least one ground engaging member fixedly attached to the base.

Another embodiment of the present invention may include an edging wall comprising at least two modular edging units rotatably and removably attached, each modular edging unit further comprising an outer edge which presents a substantially smooth and uniform transition between the edging units.

In another embodiment of the present invention, the viewable or visible wall of the edging piece may be in the form of and/or give the appearance of generally vertical pickets.

In another embodiment of the present invention the body of the edging piece may comprise a lattice pattern wherein there are open spaces between a slat-like arrangement forming the lattice pattern.

The present invention provides a fence-like, generally decorative, barrier, edging, or border structure and individual edging pieces for forming such a structure edging.

In one embodiment, each piece of the edging is designed to be an interchangeable modular unit. In addition, each piece is designed for easy engagement to adjacent pieces of the generally same and/or similar style. There are no starting or finishing end pieces, and each modular edging piece can be attached to other modular edging pieces at any desired angle to form an elongated barrier, edging or border structure of any desired length or pattern in or on the ground. In addition, no specialized corner pieces are required. The modular edging pieces of the present invention can be engaged to adjacent pieces at almost any angle and still present a substantially smooth and uniform outer edge around the base of the assembly. A smooth outer edge for varied angle attachment may provide a particularly attractive structure for use in lawn or garden or yard application.

The present invention contemplates use of the edging material of the present invention in any outdoor setting. The edging can be constructed around a garden, along a sidewalk, generally adjacent to trees, shrubs, gazebos, or in any other area in which a user might wish to decorate an area or create a border. The edging 16 of the present invention can also serve as a barrier. The barrier can separate plants, retain items such as mulch from spreading, or delineate separate areas or sections of ground space.

The present invention relates to an improved edging strip for use in separating areas. The present invention is particularly useful for separating areas with different landscaping features, for example, those areas that are rocked versus those areas that might have wood chips or peat moss. The present invention may, at the same time, add an aesthetically pleasing accent. The edging strip includes an upright wall which may include a decorative pattern thereon. The edging comes in sections that are placed together by a latching mechanism and then inserted into the ground. The edging of the present invention has a novel comer edge enabling each piece to be placed together in such a manner as to present a smooth lower barrier edge. Finally, no specialized comer or angled pieces are required because each module unit of the present invention may be placed together at almost any desired angle.

### BRIEF DESCRIPTION OF THE DRAWINGS

FIG. 1 is a perspective view of one embodiment of the modular edging unit of the present invention.

FIG. 2 is an elevational view of the front surface of the edging unit depicted in FIG. 1.

FIG. 3 is a top plan view of the edging unit of FIG. 1.

FIG. 4 is an elevational view of the back side of the edging unit of FIG. 1.

FIG. 5 is an elevational view of a fence structure made up of a number of edging units of the present invention.

FIG. 6 is a top plan view of two edging units of the present invention connected at an angle.

FIG. 7 is an elevational side view of one embodiment of the modular edging unit of the present invention.

FIG. 8 is a front elevational perspective view of another embodiment of a modular edging unit in accordance with the present invention.

FIG. 9 is a rear elevational view of an the modular edging unit of FIG. 8.

FIG. 10 is a front elevational view of the edging unit of FIG. 8.

### DESCRIPTION

Any references to front and back, right and left, top and bottom, and upper and lower are intended for convenience of description, not to limit the present invention or its components to any one positional or spatial orientation. As used herein, the terms “decorative border edging fence”, “edging”, “barrier,” “edging unit, piece or section,” or “lawn and garden edging material” are intended to mean and/or encompass structures, devices or apparatus for forming and/or defining boundaries, topsoil boundaries, lines and/or areas within or outside boundaries, and “edging” may be used to refer to individual units or pieces used to form an elongated wall or fence-like structure of a selected length and to the wall or fence-like structure formed by the individual units or pieces. Such structures, devices or apparatus are frequently used in and around gardens, bushes, trees and the like for, e.g., forming a boundary, supporting, decorating, or protecting. The edging material of the present embodiment is made of plastic, such as a form of polyethylene, and the individual sections may be approximately one foot in length. In alternative embodiments, the edging may be made of any material known to those skilled in the art and the length may be varied.

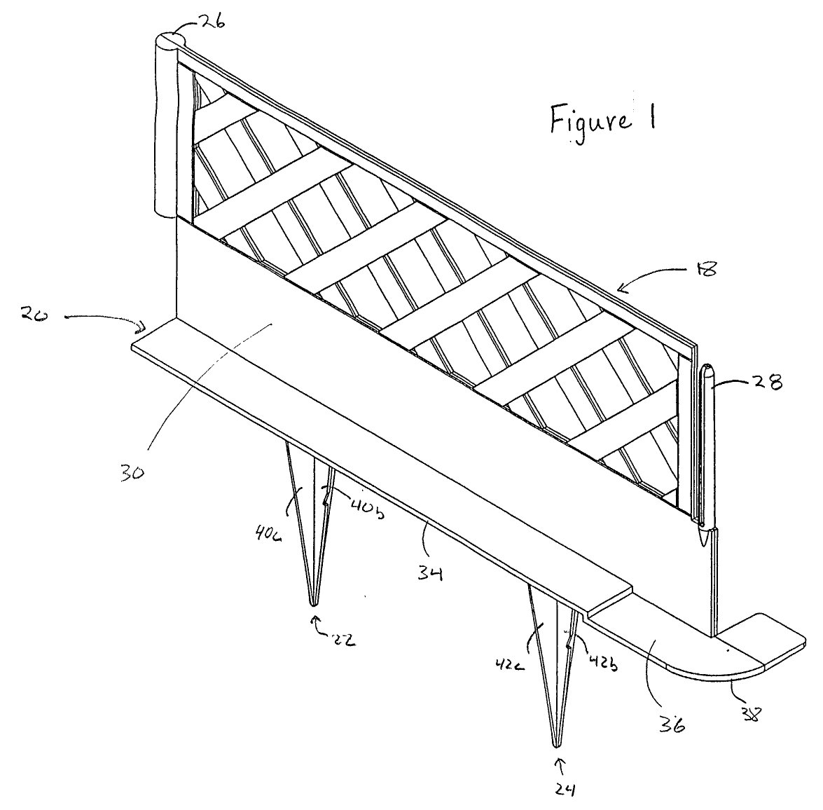

As illustrated in FIGS. 1-4 and 7, the edging pieces 16 of the present invention which may be used to form a fence-like edging of a selected length, comprise a substantially continuous planar wall 18, a base 20, a ground edging member 22, a ground edging member 24, a receptacle connection member 26, and an insertion connection member 28. In use, the flat wall 18 may be positioned in a generally vertical position extending upwardly from the platform base 24. The first and second ground engaging members 22, 24 may be operably affixed to the bottom side of the base 20, extending away therefrom in a downwardly direction, opposite that of the wall 18. The base 20 may extend a related distance generally perpendicularly of the plane formed by the wall 18. The insertion connection member 28 may be affixed to one end of the wall 18, and extend in a generally upwardly direction away from the base 20. The insertion connection member 28 may be an insertion type connector designed to be inserted into as telescopically operably fitted into the receptacle connection member 26. The connection member 26 may be affixed to the opposite end of the wall 18. The connection member 26 may be thought of as receptacle for receiving the insertion connection member 28, and may be in a generally vertical alignment and at such a height to receive the connection member 28 when two modular pieces of the present embodiment edging 16 are joined.

As is illustrated in FIGS. 1, 2 and 4, the wall 18 of the present invention will be herein further described. In one embodiment, the wall 18 may include a first side 30 and a second side 32. The first side 30 may have a pattern molded, painted, or otherwise provided thereon to present a selected aesthetically pleasing view. The second side 32 may also have such a pattern thereon, or may be plain. Making the second side 32 of the wall 18 without pattern or ornamentation may reduce the cost of producing the wall 18. Placing a pattern on the wall 18 of the edging 16 may contribute to the aesthetics of the edging 16, and may also serve to conceal marks, scratches, and other imperfections in the wall 18, whether due to manufacturing or due to normal wear and tear during use.

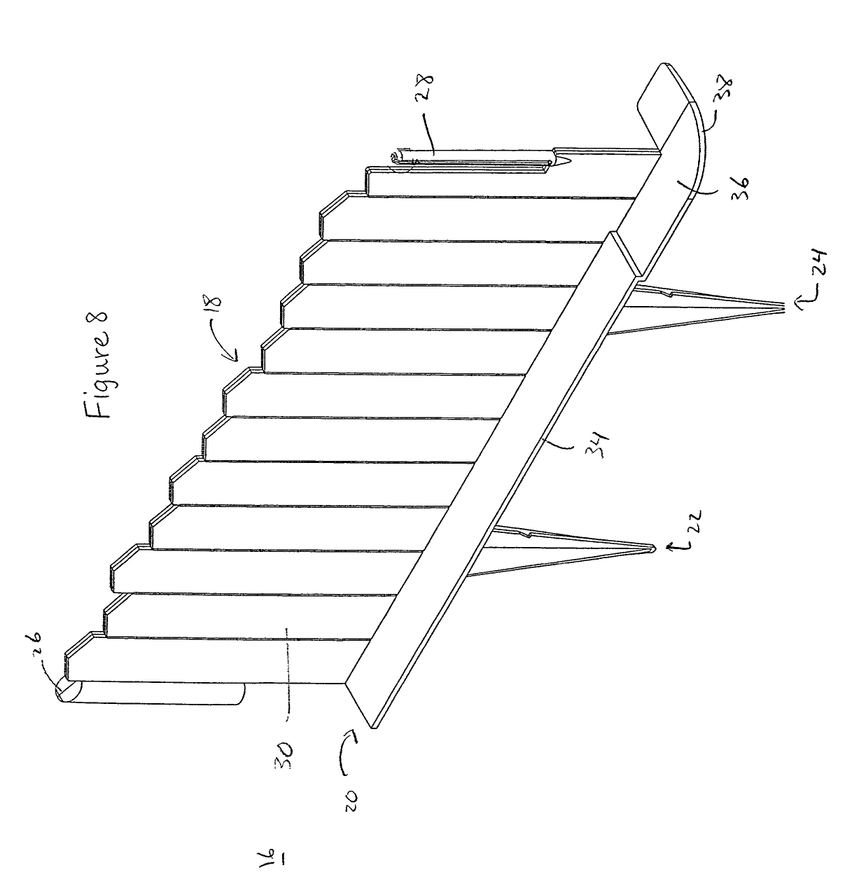

In this embodiment, the wall 18 of the present invention provides the barrier, border or fence effect, i.e., the separation effect of the edging 16. The wall 18 may be approximately 5.75 inches in height (as measured above the base) and a few tenths of an inch thick. The height and thickness of the wall 18 may be changed without changing the nature and scope of the present invention. As may be appreciated, where the edging 16 requires more structural strength and/or rigidity, or requires a different thickness to present a desired aesthetic pattern or design, the wall 18 may be thicker or thinner as desired by the end user. As illustrated in FIGS. 1 and 8, a variety of patterns or structures may be formed by the wall 18 of the present invention. In still further embodiments, the wall 18 may not be generally planar or flat, but instead may be a concave or rounded structure or may include curved or rounded portions.

The wall 18 may be made of molded plastic, although in alternative embodiments, the wall 18 may be made of any suitable material, including materials that are similar or different to the other portions of the edging of the present invention. In one embodiment, the wall 18 may be made of a stronger or weaker plastic material than the base 24 and the first and second insertion members 22, 24. In other embodiments, the wall 18 may be made substantially of wood, concrete, metal etc. the alternative material being affixed to the base 20 in a manner known to those skilled in the art, such as with adhesives, spikes, staples, screws, nails, etc.

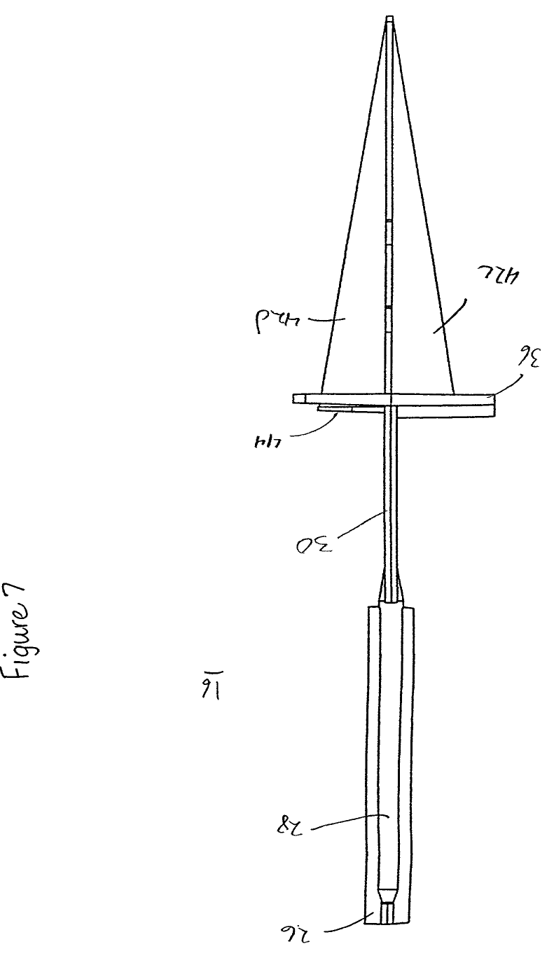

With reference to FIGS. 1, 2, 3, and 6, in one embodiment the base 20 of the present invention is approximately 1 inch in diameter and may be a few tenths of an inch thick. In one embodiment, the base 20 has an outside edge 34 and a base extension 36. The base extension 36 may extend slightly beyond the end of the wall 18 and the insertion member 24. In the present embodiment, the base extension 36 may start at a distance before the end of the wall 18 and may be on a slightly lower plane than the remainder of the base 20. As illustrated in FIG. 7, the base extension 36 may also form a ninety-degree turn in the direction of the backside of the edging 16 and may include a generally smooth outer edge radius 38. In the present embodiment, the width of the base extension 36 may be the same as the width of the base 20 and may be slightly stepped down below the base 20. In alternative embodiments, the width of the base extension 36 may be larger or smaller without affecting the scope of the present invention.

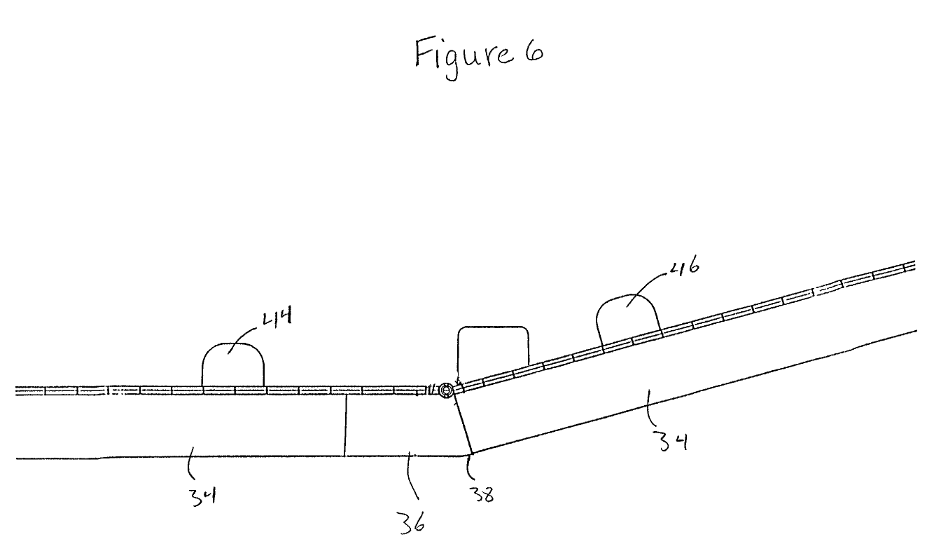

An advantage of the base extension 36 is that when two modular edging pieces 16 units are interlocked together and placed in the ground, the smooth outer radius 3 8 of the base extension 36 will align with the outside edge 34 of the corresponding base 20. Because of the radius 38, the base extension 36 will align with the outside edge 34 of the base 20 notwithstanding the angle between the two edging pieces. See FIG. 6. The slightly lower base extension 38 further may allow the base 20 of the next successive or adjacent modular edging pieces to rest on the extension 38. Since the extension 38 and the base 20 are of the same width, the view presented as the extension 38 meets the base 20 may be smooth and pleasing to the eye. See FIGS. 1, 5, and 6. Another advantage is that the outside edge 34 integrates with the radius 38 in a smooth transition. The smooth transition between the base extension 36 of one base 20 and the beginning of the next base 20 provides an attractive appearance to the edging 16 after it has been placed into position. Furthermore, the need for specialized comer pieces is eliminated, as any two modular edging pieces may be utilized to form a comer of any desired angle. Another advantage of the edging pieces of the present invention, particularly the extension 38, is that when installed, the extension(s) 38 will rest generally horizontally relative to the ground, i.e., as just below the ground surface, thereby enhances the stability of the edging assembly, making it more difficult for the wall portion of the edging to be pushed or deflected from its generally vertical installed position, in other words, enabling the lateral stability of the top of the edging. Also, they serve to enhance the rigidity and structural integrity of a fence-like edging assembly when it is installed.

With reference to FIGS. 1, 4 and 7, the ground engaging members 22 and 24 may be generally flange-like integral members. The ground engaging members 22, 24 provide anchoring structures for fixing the edging pieces 16 to the ground. They comprise four radially extending flanges 40a-d and 42a-d and an insertion head 44 and 46. In one embodiment, the first and second radial flanges 40a-b and 42a-b extends parallel to the length of the modular edging piece 16 and the third and fourth flanges 40c-d and 42c-d may extend perpendicular to the length of the modular edging piece 16 fence. The first and second flanges 40a-b and 42a-b of the present embodiment may extend approximately 0.5 inches radially from the center of the insertion members 22 and 24 and the third and fourth flanges 40c-d and 42c-d may extend approximately 0.75 inches radially from the center of the insertion members 22 and 24. Each insertion member 22 and 24 narrows (i.e., the flanges extend outwardly a smaller radial distance) as the engaging member extends away from the base 20, thereby forming a point. The point of the insertion member 22 and 24 facilitates the placement of the insertion members 22 and 24, and thus the modular edging piece 16, into the ground during construction of a fence in accordance with the present invention. The insertion members 22 and 24 of the present embodiment they may be approximately 4 inches in length, though in alternative embodiments may be longer or shorter. As may be appreciated, the rearwardly extending fourth flange 40d and 42d may extend beyond the base; in the present embodiment, however, the fourth flange 40d and 42d is covered by and is attached to the insertion head 44 and 46. In alternative embodiments, the size of the flanges 40a-d and 42a-d and the overall length of the members 22 and 24 may be varied without changing the nature and scope of the present invention.

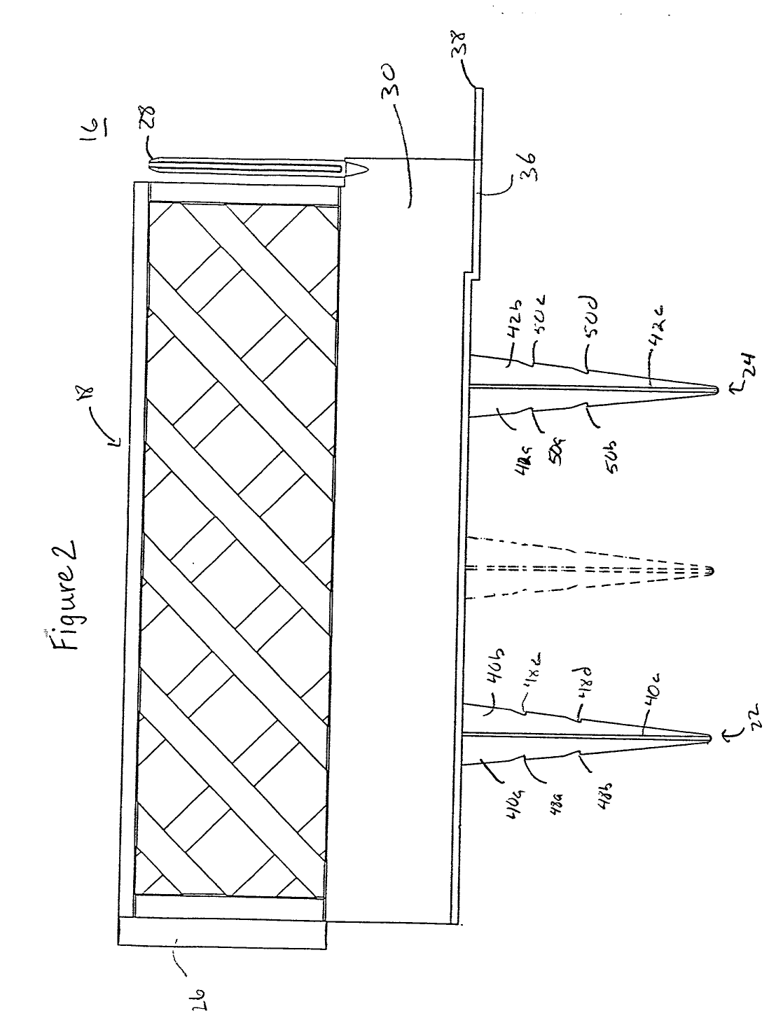

As illustrated in FIG. 2, first and second flanges 40a-b and 42a-b of the insertion member of the present invention may further comprise a number of barbs 48a-d and 50a-d disposed on the outer flange edge. The barbs 48a-d and 50a-d may catch on earth, rocks, or roots after the insertion members 22 and 24 are inserted in the ground, thereby increasing the anchoring and stability of the modular edging 16 units. In alternative embodiments, similar barbs may also be provided on the third and fourth flanges 40c-d and 42c-d, and other structures may be provided to help keep the members 22 and 24 inserted into the ground. For example, additional barbs, friction increasing structures such as bumps, irregularities and the like, or openings in the flanges may be provided.

In a further embodiment, the insertion members 22 and 24 may be substantially one unit, i.e., take the form of a continuous, tapered piece of material extending the length of an edging piece. An insertion member of this type may increase the stability of the edging unit 16 after it is placed in the ground. Other forms of members 22, 24 are within the scope of the present invention, and more than two such members may be provided as a single piece of edging.

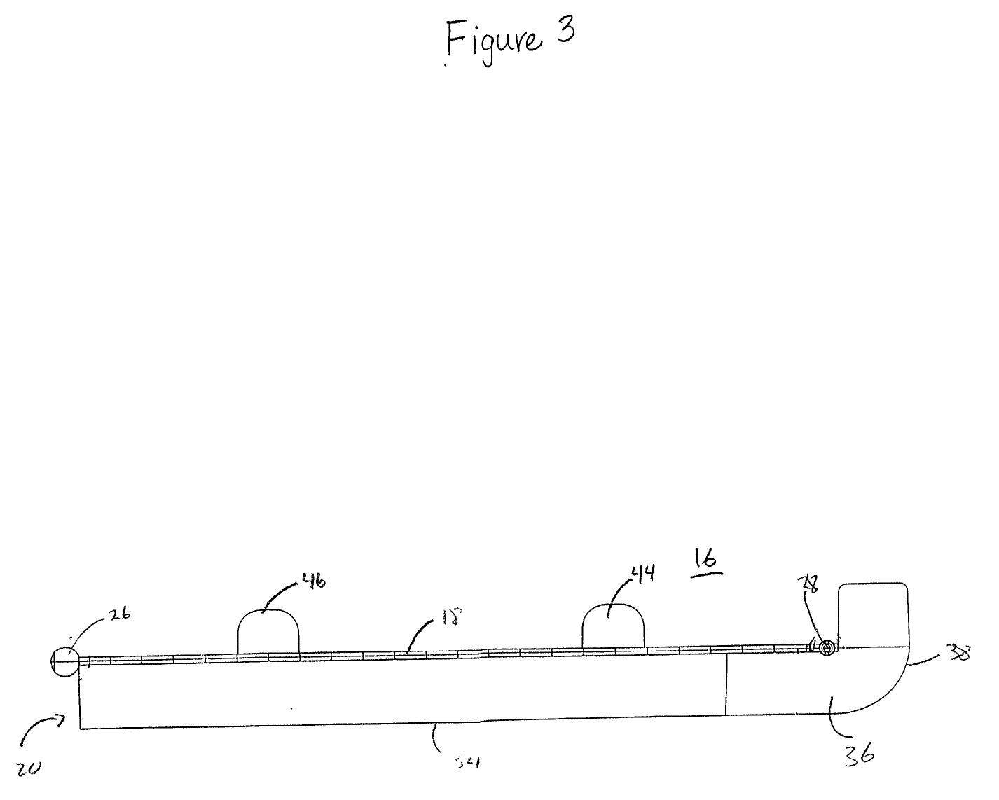

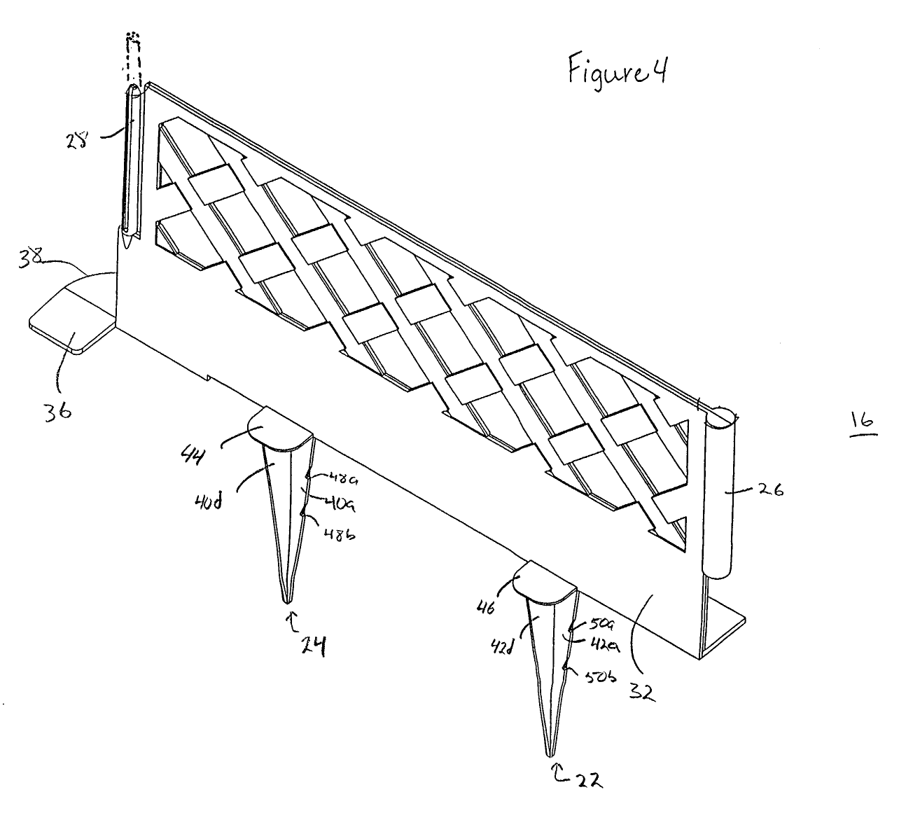

As illustrated in FIGS. 3 and 4, the insertion heads 44 and 46 may extend rearwardly behind the base 20 and beyond the back edge of the wall 18. The insertion heads 44 and 46 of the present embodiment are designed to receive a generally downward force exerted by the user during the installation of the edging pieces. The insertion heads 44 and 46 are positioned directly over the insertion members 22 and 24 in order to transfer an insertion force directly to the members 22 and 24, thus avoiding placing of undesired strain on the edging piece 16, its wall 18 and base 20. In the one present embodiment, the insertion heads 44 and 46 are of a size and shape to ameliorate inserting the edging 16 units by hand by accommodating a thumb or forefinger. In alternative embodiments, the insertion heads 44 and 46 may be reinforced by making them thicker or constructing them of a harder material. In this alternative embodiment the heads 44 and 46 may be particularly reinforced, allowing the use of a hammer or other tools to drive the connection members into the ground. Using tools during the placement of the edging 16 may be advantageous if the edging is being placed in hard soil. In another alternative embodiments the edging material may be easily placed into the soil by first softening the soil using water.

One advantage of the insertion heads 44 and 46 is that they help the easy insertion of the decorative border edging into the ground. Since the insertion heads 44 and 46 avoid placing strain on the wall 18 when the edging 16 is inserted into the ground, thus, the wall 18 may be thinner. A thinner wall 18 may be easier to make, require less material, and may allow for a variety of more delicate appearing wall 18 designs. Further, minimizing the strain of insertion on the wall 18 means there will be less breakage and deformation of the wall 18 during installation. Another advantage of the insertion heads 44, 46 is that they contribute positively to the stability of the installed edging because, when the edging is installed their underside typically will be generally horizontal and in contact or just under the ground. This helps maintain the installed edging in its generally vertical installed position.

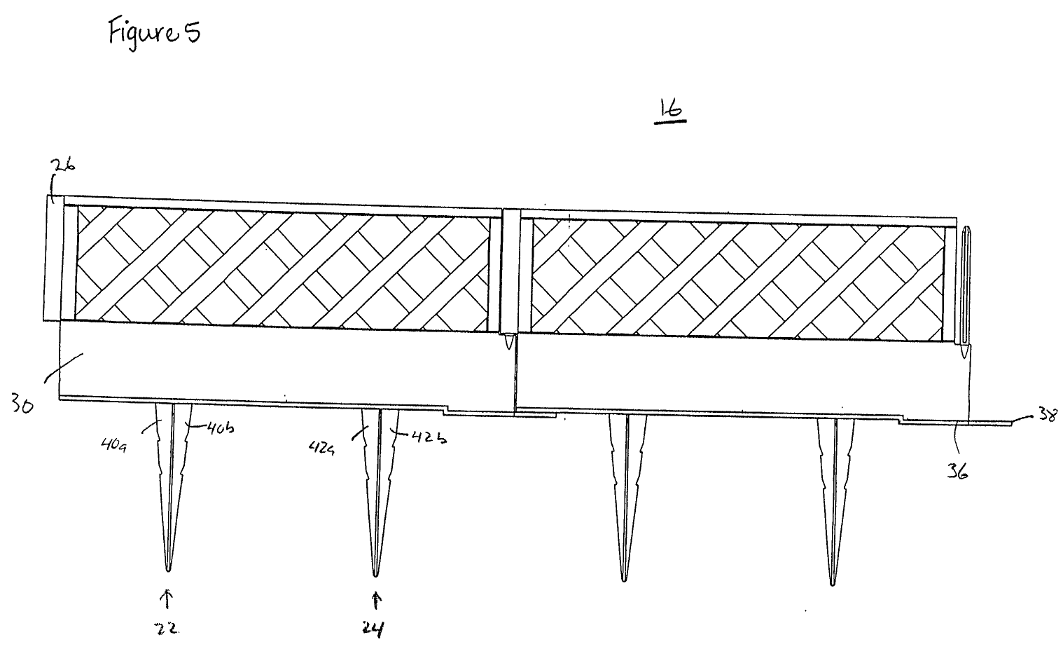

With reference to FIGS. 4 and 5, in one embodiment the insertion connection member 28 is generally cylindrical shaft approximately 0.3 inch in diameter and approximately 3 inches in height, and is integrated with the wall 18. In alternative embodiments, it may be attached directly to the base 20.

With continued reference to FIGS. 4 and 5, the connection member 26 is a hollow generally tabular cylinder with a closed upper end, and an inner cavity slightly wider in diameter than the shaft of the insertion connection member 28 and approximately the same length. In some embodiments, the receptacle member connection member 26 may have an open end on the bottom side of the cylinder and a closed end on the top side of the cylinder. The connection member 26 may be attached to the wall 18 at a height such that the bottom end is adjacent to the top of the base 20.

In order to connect adjacent edging pieces 16 when making a fence of the present invention, the connection member 26 should be connected to the connection member 28. When a first piece is placed, a piece 16 may be placed so that the connection member 26 fits over the connection member 28, interlocking the two edging pieces 16 together. As may be appreciated, the hinge-like complementary connection members 26, 28 enables the connection of edging pieces 16 at virtually any angle.

As illustrated in FIG. 1, it may be observed that the connection member 28 and the connection member 26 do not extend to the full height of the wall 18 of the present embodiment edging 16. In alternative embodiments, the height of the connection member 28 and the connection member 26 may be altered without changing the nature and scope of the present invention. Furthermore, other changes may be made to the connection member 28 and the connection member 26, such as, for example, leaving the top end of the connection member 26 open. In still further embodiments, the insertion connection member 28 may extend above the open top of the connection member 26. In yet another embodiment, as shown in phantom in FIG. 1, a portion of the connection member 28 may extend above the receptacle member 26 to allow the attachment of a variety of decorative structures, e.g., a flag or windmill having a tubular base may be slipped onto the exposed, upstanding end of the connection member 28. In still further embodiments, a locking system may be integrated to provide further structural support to the fence made of the edging units 16.

Placement of the Modular Edging Units

The installation or placement of modular edging units 16 to form an elongated edging or barrier structure involves placing the first edging piece 16 in the ground in a desired location and orientation. The edging pieces 16 may be placed by exerting downward pressure on the insertion heads 44 and 46. In the present embodiment the pressure may be exerted by hand, or in the alternative embodiments described, by various tools known to those in the art. The second edging piece 16 may then be brought down in such a manner that the receptacle connection member 26 of the second edging piece 16 fits over the insertion connection member 28 of the first piece 16 unit. The second piece 16 unit may be brought down, at the desired angle relative to the first piece. In this manner an edging fence comprised of immediately adjacent, connected successive modular piece 16 may be created in a straight line, a curved line or at any desired angle or shape.

Because of the base extension 36 and the smooth outer edge radius 38, the fence appears to be continuous, i.e., when successive modular edging 16 units are placed and joined, the transition or joint between successive piece 16 is smooth and without gaps.

Creating a consistent and smooth transition between edging 16 units, no matter the connection angle, is advantage of the present invention. Smooth transition between edging 16 units provide an aesthetically pleasing edging 16 barrier.

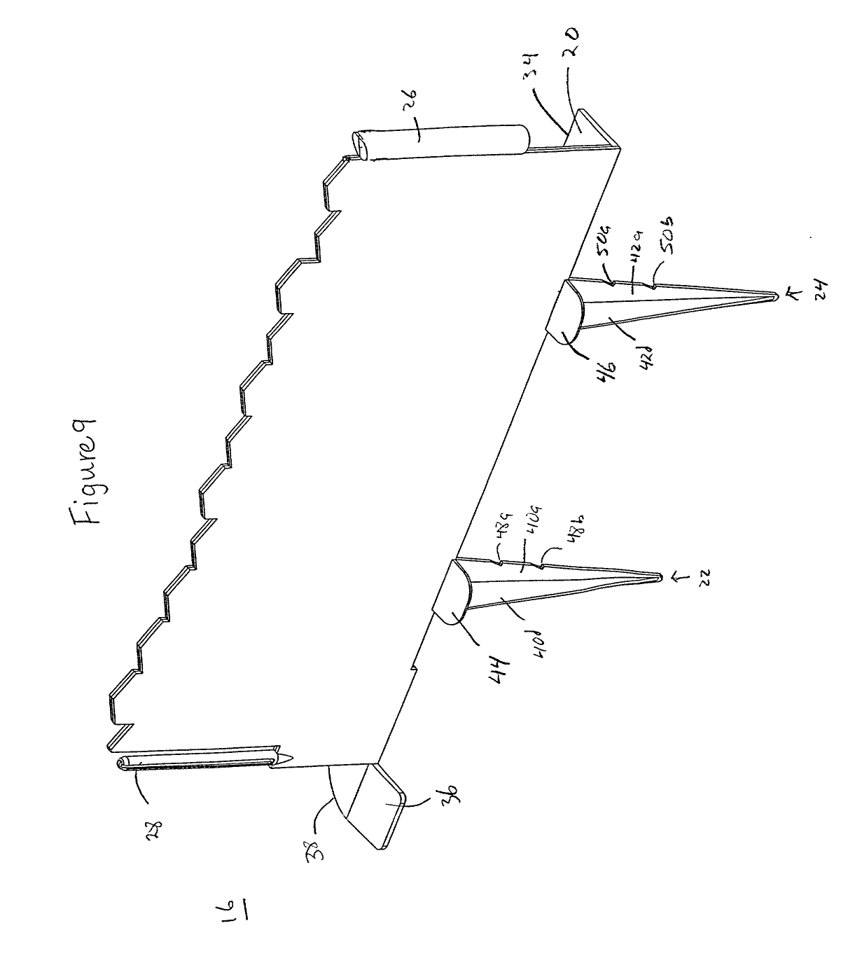

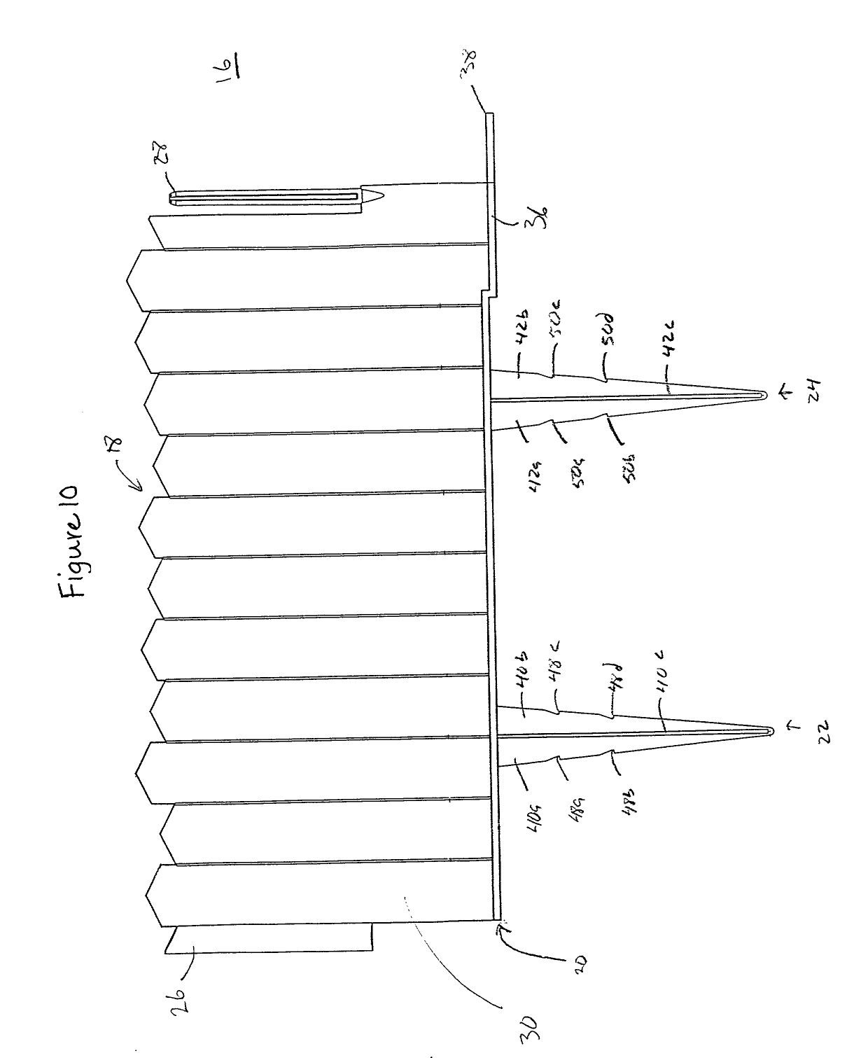

In alternative embodiments, the modular edging pieces of the present invention may come in longer or shorter units and the wall portion 18 may be of any desired height. Furthermore, depending on the height of the wall, the length of the first and second insertion members 22, 24 may be adjusted. A higher wall 18 may require insertion members 22, 24 of a longer length, a shorter wall 18 may be able to utilize shorter insertion members 22, 24 and still achieve adequate stability. In addition, if the modular edging 16 piece reaches a certain length, it may be advantageous to add additional insertion members (e.g., a third member as shown in phantom in FIG. 2); alternatively, if the modular edging piece is short enough, the number of insertion members may be reduced. An alternative embodiment wall structure 18 is illustrated in FIGS. 8-10. The present embodiment connection member 26 and connection member 28 may be alternatively described as a hinge system, comprising a sleeve or barrel member and a pin member wherein edging pieces may be removably joined and/or pivotally fitted coupled together by sliding the sleeve of one section over the pin member of another section. The sleeve may be formed by molding or curling a flat flange into the cylindrical shape or barrel for receiving the pin.

In another embodiment of the present invention (not shown), the connection members may comprise a male snap member and a female snap member. The male snap member is a plastic member with a generally circular outside diameter. The female snap member is a plastic member with an open and generally circular inside diameter. The two snap member diameters are of substantially the same size so that when the two are brought together the male member tightly fits inside the female member.

In another embodiment of the present invention, the ground engaging members may be comprised of a plurality of nestable stakes or spikes that fit through holes formed in the above described base and then into the ground. Other ground engaging members may be envisioned by those skilled in the art.

The top edge of the edging may be a continuous straight edge parallel to the bottom edge or it may be picket-like, curved or otherwise shaped. The base may be continuous for the length of an edging piece, or it may comprise a selected member of base portions spaced along the length.

The accompanying Figures and this description depict and describe embodiments of the present invention, including features and components thereof. With regard to fastening, mounting, attaching, or connecting the components of the present invention to form the invention as a whole, unless specifically described otherwise, the invention may incorporate or use conventional fasteners such as: screws, nut and bolt connectors, machined connectors, snap rings, complementary fittings and interlocks, such as snap, threaded, tongue and groove, or plug/socket arrangements and the like, clamps such as screw clamps and the like, rivets, toggles, pins and the like. Components may also be connected, if appropriate, by adhesives, welding, friction fitting or deformation. Unless specifically otherwise disclosed or taught, materials for making components of the present invention may be selected from appropriate materials such as metal, metallic alloys, fibers, fabrics, plastics and the like, natural or synthetic. In addition, ultra violet stabilizers and other materials may be added to the construction to further enhance the durability of the barrier edging while it is in use. Appropriate manufacturing or production methods may be used to produce the edging material, e.g., casting, extruding, weaving, spinning, molding, and machining.

Various changes, including those mentioned above, can be made without deviating from the scope of the present invention. Accordingly, it is intended that the scope of the present invention be determined by the appended claims rather than by the foregoing description.

1. A modular edging unit comprising:
a first end and a second end;
a base extending from the first end to the second end of the modular edging unit;
a substantially vertical barrier disposed on a top side of the base and running substantially from the first end to the second end of the modular edging unit;
an at least one ground engaging member fixedly attached to the base; and
means for attaching the edging piece to substantially similar second and third edging pieces.

2. The modular edging unit of claim 1 wherein the base further comprises an outside edge wherein when two successive modular edging units are affixed, the outside edge of the base of the second modular edging unit smoothly integrates with the outside edge of the base of the first modular edging unit.

3. The edging piece according to claim 2, wherein said extension comprises a portion extending generally laterally with respect to the wall.

4. The modular edging unit of claim 1 wherein the base further comprises an extension member on the second end, the extension member having an inside edge and outside edge, the outside edge curving in a smooth radial arc.

5. The modular edging unit of claim 4 further comprising:
a first attachment member fixedly attached to the first end of the edging unit; and
a second attachment member fixedly attached to the second end of the edging unit whereby the second attachment member is shaped to operably couple with the first attachment member of an adjoining modular edging device at any desired radial angle.

6. The modular edging unit of claim 5 wherein the barrier is substantially vertical.

7. The modular edging unit of claim 6 wherein the first attachment member is complementary to the second attachment member of the substantially similar second edging piece, and wherein the second attachment member is complementary to the first attachment member of the substantially similar third edging piece.

8. The modular edging unit of claim 7 wherein the outside edge of the extension member smoothly curves until it is substantially perpendicular to the starting point.

9. The modular edging unit of claim 8 wherein when a second modular edging unit is connected to a first modular edging unit, the base of the second modular edging unit smoothly. joins with the extension member of the first modular edging unit.

10. The modular edging unit of claim 9 wherein the extension member is fixedly attached on a lower plane than the base.

11. The modular edging unit of claim 1 wherein the first attachment member is a pin member and the second attachment member is a barrel member.

12. The modular edging unit of claim 1 wherein the at least one ground engaging member further comprises a plurality of flanges.

13. The modular edging unit of claim 1 wherein the at least one ground engaging member further comprises an insertion head.

14. The modular edging unit of claim 1 wherein the substantially vertical barrier is a wall.

15. The modular edging unit of claim 1 wherein the substantially vertical barrier simulates a lattice of structure.

16. The modular edging unit of claim 1 wherein the substantially vertical barrier simulates a picket structure.

17. A modular edging unit comprising:
a wall;
a base connected to a lower portion of the wall wherein the base has an outer edge, one end of the edge including a radially curved portion; and
at least one ground engaging member fixedly attached to the base.

18. The modular edging unit of claim 17, further comprising:
a first connection member attached to a first end of the wall; and
a second connection member attached to a second end of the wall, the second connection member removably connected to the first connection member of a substantially similar adjacent modular edging unit whereby the adjacent edging units are angularly positioned relative to each other.

19. The modular edging unit of claim 18 wherein the ground engaging member is a stake.

20. The modular edging unit of claim 18 wherein the ground engaging member is a spike.

21. The modular edging unit of claim 18 wherein the ground engaging member is one substantially thin and downwardly extending piece which runs from the first end to the second end of the edging unit.

22. The modular edging unit of claim 21 wherein the ground engaging member further comprises an at least one flange, the flange radially extending from the ground engaging member.

23. An edging wall comprising an at least two modular edging units removably attached at a desired angle relative to each other, each modular edging unit further comprising an outer edge which presents a substantially smooth and uniform transition between the edging units.

24. The edging wall of claim 23 wherein each modular edging unit further comprises an at least one ground engaging member.

25. The edging wall of claim 23 wherein each modular edging unit further comprises a first connection member and a second connection member, the second connection member rotatably and removably attached to the first connection member of an adjacent modular edging unit.
